(19) United States
(12) Patent Application Publication
(10) Pub. No.: US 2011/0124789 A1
(43) Pub. Date: May 26, 2011

(54) COLORED LONG FIBER REINFORCED PELLET AND COLORED RESIN ARTICLE MANUFACTURED BY USING THE SAME

(75) Inventors: Jae Rim Choi, Seoul (KR); Hyun Ho Cho, Seoul (KR); Jong-Min Chae, Seoul (JP); Joung Tae Seo, Seoul (KR)

(73) Assignee: GS CALTEX CORPORATION, Seoul (KR)

(21) Appl. No.: 12/674,572

(22) PCT Filed: Aug. 28, 2008
(86) PCT No.: PCT/KR2008/005043

§ 371 Date: Feb. 22, 2010

(30) Foreign Application Priority Data
Aug. 31, 2007 (KR) 10-2007-0088482

(51) Int. Cl. C08L 23/26; C08K 3/30; B82Y 30/00

(52) U.S. Cl. 524/420; 524/582; 524/584; 524/528; 428/402; 977/810; 977/811; 977/788; 977/902

(57) ABSTRACT

Disclosed is a long fiber-reinforced colored pellet. The long fiber-reinforced colored pellet may include a thermoplastic polymer resin, a fiber reinforced material having a length of about 5 to 50 mm, and a pigment. In this instance, the thermoplastic polymer resin has a melt index (MI) of about 0.1 to 80 g/10 min at about 230° C. and under about 2.16 kg load, and a surface hardness of the pigment is about 5 or less.

### TECHNICAL FIELD

The present invention relates to a long fiber-reinforced colored pellet and an article manufactured using the same, and more particularly, to a long fiber-reinforced colored pellet, a pellet composition for a reinforced resin with a colored pellet and long fiber-reinforced pellet mixed therein, and a colored resin article manufactured using the same, which may minimize a deterioration in mechanical properties of colored articles

### BACKGROUND ART

Long fiber-reinforced thermoplastic polymer materials are widely utilized in the entire household electric appliances industry, building material industry, and the like due to their excellent recyclability and moldability, and superior physical properties such as excellent mechanical property and low coefficient of liner expansion as compared with short fiber-reinforced polymer materials. In particular, the use application is expanded in the automotive industry where recycling characteristics and lightening characteristics are required.

However, the mechanical property of the long fiber-reinforced polymer material may be deteriorated due to even a small amount of a pigment for coloring. Accordingly, an amount of reinforcement materials for the long fiber is required to increase in order to overcome the deterioration in the mechanical property when colored products are required, and thus a weight of an article and costs thereof may increase.

In order to solve the above-mentioned problems, a method in which the mechanical property is reinforced using polyamide has been known in the related art, however, the mechanical property may be deteriorated when using a polymer other than the polyamide. Also, a method in which an amount of a pigment contained in a master batch of a coloring agent manufactured separately is required to be limited to a low concentration of 15% or less when performing a dry mixing of the master batch and a product containing the long fiber-reinforced material has been suggested in the related art. However, in the above-mentioned related art, additional process costs for manufacturing a separate master batch of the coloring agent are required, and an amount of a pigment within the coloring agent is required to be limited to a relatively low level. As a result, in order to achieve a desired coloring effect, more master batches of coloring agent are required to be used than usual, thereby increasing costs.

### DISCLOSURE OF INVENTION

### Technical Goals

An aspect of the present invention provides a long fiber-reinforced colored pellet which may exhibit excellent mechanical properties even when the long fiber-reinforced colored pellet contains a large amount of coloring agent.

An aspect of the present invention provides a long fiber-reinforced colored pellet which may minimize a deterioration in its mechanical properties according to mechanical properties and types of a coloring agent.

An aspect of the present invention provides a pellet composition for a reinforced-resin which may exhibit the same composition and effect as in the long fiber-reinforced colored pellet upon manufacturing an article.

An aspect of the present invention provides a colored resin article which may be manufactured by the long fiber-reinforced colored pellet and the pellet composition for the reinforced-resin, and exhibit excellent mechanical properties.

### Technical Solutions

According to an aspect of the present invention, there is provided a long fiber-reinforced colored pellet, including: a thermoplastic polymer resin; a fiber reinforced material having a length of about 5 to 50 mm; and a pigment. In this instance, the thermoplastic polymer resin may have a melt index (MI) of about 0.1 to 80 g/10 min at about 230° C. and under about 2.16 kg load, and a surface hardness of the pigment is about 5 or less.

Also, the long fiber-reinforced colored pellet may include: about 10 to 90 wt. % of the thermoplastic polymer resin; about 5 to 85 wt. % of the fiber reinforced material; and about 0.01 to 5 wt. % of the pigment.

Also, the fiber reinforced material may have a mean diameter of about 0.3 to 50 μm, be immersed in the pellet to be parallel to a lengthwise direction of the pellet, and have the same length as that of the pellet.

Also, the pigment may be at least one compound selected from a group consisting of ZnS, carbon black, and lithopone.

Also, the pigment may have a mean particle size of about 20 nm or less.

Also, the pigment may have a mean particle size of about 30 nm or less, and is carbon black having an oil absorption number of about 70 cc/100 g or more.

Also, the pigment may include carbon black having an oil absorption number of about 70 to 150 cc/100 g.

Also, the thermoplastic polymer resin may include at least one polymer resin selected from a group consisting of polypropylene, polyamide, polystyrene, styrene acrylonitrile (SAN), acrylonitrile-butadiene-styrene (ABS), polycarbonate (PC), polyurethane (PU), polyoxymethylene (POM), polyethylene terephthalate (PET), polytrimethylene terphthalate (PTT), poly butylene terephthalate (PBT), poly phenylene sulfide (PPS), poly phenylene ether (PPE), poly ether ether kentone (PEEK), liquid crystal polymer (LCP), polyarylate (PAR), poly methyl pentene (PMP), polysulfone (PSU), poly ether sulfone (PES), and polyimide (PI).

Also, the thermoplastic polymer resin may be polyolefin based-polymer, in which at least one copolymer is mixed, the at least one copolymer being selected from a group consisting of ethylene-α-olefin copolymer with three or more carbon atoms, and styrene-diene copolymer.

Also, the ethylene-α-olefin copolymer may include at least one copolymer selected from a group consisting of ethylene-propylene copolymer, ethylene-butene-1 copolymer, and ethylene-octene copolymer.

Also, the styrene-diene copolymer may include at least one copolymer selected from a group consisting of styrene-butylene-styrene block copolymer, styrene-ethylene-butylene-styrene block copolymer, stylene-isoprene-stylene block copolymer, and stylene-ethylene-propylene-stylene block copolymer.

Also, the polyolefin based-polymer may be modified by unsaturated carboxylic acid and a derivative of unsaturated carboxylic acid.

Also, the polyolefin based-polymer may be grafted in at least one polar group selected from a group consisting of unsaturated carboxylic acid, a derivative of unsaturated carboxylic acid, and an organosilane compound, and a degree of grafting is about 0.3 to 5 wt. %. In this instance, the unsaturated carboxylic acid and the derivative of unsaturated carboxylic acid may be at least one compound selected from a group consisting of maleate, fumaric acid, acrylic acid, itaconic acid, methacrylic acid, maleate anhydride, itaconic anhydride, maleate monoamide, acrylic acid amide, and methacrylic acid natrium. In this instance, the organosilane compound may be at least one compound selected from a group consisting of amino silane, epoxy silane, vinyl silane, and methacryloxy silane.

Also, the fiber reinforced material may be at least one fiber selected from a group consisting of glass fiber, carbon fiber, metal fiber, nylon fiber, PET fiber, PEEK fiber, LCP fiber, polyacrylonitrile (PAN) fiber, ultra-high molecular weight polyethylene (PE) fiber, aramid fiber, and natural fiber.

Also, the long fiber-reinforced colored pellet may further include: at least one additive selected from a group consisting of antioxidant, neutralizer, nucleant, anti-electrostatic agent, frame retardant, polish, ultraviolet stabilizer, slip agent, release agent, dispersing agent, and inorganic filter. In this instance, the additive may be used for stability of polymer, reduction in costs, and the like, and may be used in a range where mechanical property, appearance characteristics, deformable characteristics, and the like may not be rapidly reduced. In this instance, as the antioxidant, phenol-based antioxidant, phosphate-based antioxidant, thiodipropionate synergist, and the like ma be used. In this instance, as the neutralizer, calcium stearate, zinc oxide, and the like may be used. In this instance, as the inorganic filter, talc, mica, clay, calcium carbonate, barium sulfate, glass bubble, glass bead, ceramic bubble, whiskers, chopped class fiber, and the like may be used.

According to an aspect of the present invention, there is provided a pellet composition for a reinforced resin, including: a colored pellet including about 50 to 90 wt. % of a first thermoplastic polymer resin, and about 10 to 50 wt. % of a pigment having a surface hardness of about 5 or less; and a long fiber reinforced pellet including about 10 to 90 wt. % of a second thermoplastic polymer resin, and about 10 to 90 wt. % of a fiber reinforced material having a length of about 5 to 50 mm. In this instance, the colored pellet and the long fiber reinforced pellet may be mixed in a weight ratio of about 0.02:99.98 to 50:50. Also, the pellet composition may further include a resin pellet including a third thermoplastic polymer resin.

Also, the pellet composition may be mixed with the colored pellet and the long fiber-reinforced pellet, so that the pellet composition may further include: about 10 to 90 wt. % of a thermoplastic polymer resin; about 5 to 85 wt. % of a fiber reinforced material having a length of about 5 to 50 mm; and about 0.01 to 5 wt. % of a pigment having a surface hardness of about 5 or less. In this instance, the thermoplastic polymer resin may be mixed with a first and second thermoplastic polymer resin. Also, the first and second thermoplastic polymer resin may be the same type or different type.

Also, the pellet composition may be mixed with the colored pellet, the long fiber-reinforced pellet, and the resin pellet, so that the pellet composition may further include: about 10 to 90 wt. % of a thermoplastic polymer resin; about 5 to 85 wt. % of a fiber reinforced material having a length of about 5 to 50 mm; and about 0.01 to 5 wt. % of a pigment having a surface hardness of about 5 or less. In this instance, the thermoplastic polymer resin may be mixed with a first, second, and third thermoplastic polymer resin. Also, the first, second, and third thermoplastic polymer resins may be the same type or different type.

Also, the first, second, and third thermoplastic polymer resins may be the same type as the thermoplastic polymer resin included in the long fiber-reinforced colored pellet. Specifically, the first, second, and third thermoplastic polymer resins may include at least one polymer resin selected from a group consisting of polypropylene, polyamide, polystyrene, styrene acrylonitrile (SAN), acrylonitrile-butadiene-styrene (ABS), polycarbonate (PC), polyurethane (PU), polyoxymethylene (POM), polyethylene terephthalate (PET), polytrimethylene terphthalate (PTT), poly butylene terephthalate (PBT), poly phenylene sulfide (PPS), poly phenylene ether (PPE), poly ether ether kentone (PEEK), liquid crystal polymer (LCP), polyarylate (PAR), poly methyl pentene (PMP), polysulfone (PSU), poly ether sulfone (PES), and polyimide (PI).

Also, the first, second, and third thermoplastic polymer resins may be mixed with at least one copolymer selected from a group consisting of ethylene-α-olefin copolymer with three or more carbon atoms, and styrene-diene copolymer. In this instance, specific types and characteristics of the ethylene-α-olefin copolymer with three or more carbon atoms, and styrene-diene copolymer may be the same as above-described in the long fiber-reinforced colored pellet, and descriptions thereof will be omitted.

Also, at least one thermoplastic polymer resin of the first and second thermoplastic polymer resins may have an MI of about 0.1 to 80 g/10 min at about 230° C. and under about 2.16 kg load.

According to an aspect of the present invention, there is provided a pellet composition for a reinforced resin, including: a) a long fiber-reinforced colored pellet including about 10 to 90 wt. % of a fourth thermoplastic polymer resin, about 5 to 85 wt. % of a fiber reinforced material having a length of about 5 to 50 mm, and about 0.01 to 5 wt. % of a pigment having a surface hardness of about 5 or less; b) a colored pellet including about 50 to 90 wt. % of a fifth thermoplastic polymer resin, and about 10 to 50 wt. % of a pigment having a surface hardness of about 5 or less; and c) a long fiber reinforced pellet including about 10 to 90 wt. % of a sixth thermoplastic polymer resin, and about 10 to 90 wt. % of a fiber reinforced material having a length of about 5 to 50 mm.

In this instance, the pellet composition may further include a resin pellet including a seventh thermoplastic polymer resin.

Also, the pellet composition may include about 10 to 70 wt. % of the long fiber-reinforced colored pellet; about 5 to 80 wt. % of the colored pellet; and about 10 to 90 wt. % of the long fiber reinforced pellet.

Also, the pellet composition may be mixed with the long fiber-reinforced colored pellet, the colored pellet, and the long fiber-reinforced pellet, so that the pellet composition may further include: about 10 to 90 wt. % of a thermoplastic polymer resin; about 5 to 85 wt. % of a fiber reinforced material having a length of about 5 to 50 mm; and about 0.01 to 5 wt. % of a pigment having a surface hardness of about 5 or less. In this instance, the thermoplastic polymer resin may be mixed with a fourth, fifth, and sixth thermoplastic polymer resin.

Also, the pellet composition may be mixed with the long fiber-reinforced colored pellet, the colored pellet, the long fiber-reinforced pellet, and the resin pellet, so that the pellet composition may further include: about 10 to 90 wt. % of a thermoplastic polymer resin; about 5 to 85 wt. % of a fiber reinforced material having a length of about 5 to 50 mm; and about 0.01 to 5 wt. % of a pigment having a surface hardness of about 5 or less. The thermoplastic polymer resin may be mixed with a fourth, fifth, and sixth thermoplastic polymer resin. In this instance, the thermoplastic polymer resin may be mixed with a fourth, fifth, sixth, and seventh thermoplastic polymer resin.

Also, the fourth thermoplastic polymer resin may have an MI of about 0.1 to 80 g/10 min at about 230° C. and under about 2.16 kg load.

According to an aspect of the present invention, there is provided a colored resin article, including a fiber reinforced material, wherein a mean length of the fiber reinforced material is about 1 to 5 mm, and a surface hardness of the resin article is about 5 or less.

In this instance, the colored resin article may be formed of the long fiber-reinforced colored pellet and the pellet composition for a reinforced resin, or a combination thereof.

Also, a mean length of the fiber reinforced material that finally remains within the article manufactured from the long fiber-reinforced pellet, or the pellet composition for the reinforced resin may be about 1 mm or more, and preferably about 2 mm or more. Also, an amount of the fiber reinforced material having a length of about 1 mm or more from among all fiber reinforced materials included in the article may be about 10 to 70 wt. %, and a mean length of the fiber reinforced material may be about 1 to 5 mm.

Also, as methods for molding the article, injection molding, extrusion molding, blow molding, foam molding, gas injection molding, gas injection molding, metal insert injection molding, and the like may be used, however, the present invention is not limited thereto. In particular, the injection molding and the metal insert injection molding methods may be preferably used.

Also, the resin article may include a resin having an MI of about 0.1 to 80 g/10 min at about 230° C. and under about 2.16 kg load.

### Advantageous Effect

When molding using the pellet composition for a reinforced resin in which a long fiber-reinforced colored pellet or a colored pellet, a long fiber reinforced pellet, and the like are mixed according to the present invention, it is possible to manufacture an article having an excellent colored performance and also having excellent mechanical properties such as tensile strength, winding strength, impact strength, and the like, without deteriorating physical properties. Also, although molding using a colored pellet containing a large amount of pigment, it is possible to manufacture an excellent product without deteriorating physical properties and to reduce manufacturing costs.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. A long fiber-reinforced colored pellet according to an exemplary embodiment of the invention includes a thermoplastic polymer resin, a fiber reinforced material having a length of about 5 to 50 mm, and a pigment. In this instance, the thermoplastic polymer resin has a melt index (MI) of about 0.1 to 80 g/10 min at about 230° C. and under about 2.16 kg load, and a surface hardness of the pigment is about 5 or less.

In this instance, the long fiber-reinforced colored pellet includes about 10 to 90 wt. % of the thermoplastic polymer resin, about 5 to 85 wt. % of the fiber reinforced material, and about 0.01 to 5 wt. % of the pigment.

Also, when the surface hardness of the pigment is greater than about 5, collision between the pigment and the fiber reinforced material may occur, or damage of the fiber reinforced material may be generated due to friction in a process for producing the long fiber-reinforced colored pellet or in a process for molding a final article using the long fiber-reinforced colored pellet, thereby deteriorating mechanical properties. Thus, according to the present exemplary embodiment, the pigment having a surface hardness of about 5 or less may be used. However, in a case of a specific pigment from among the pigments having the surface hardness of about 5 or less, deterioration of the mechanical property may occur because of other characteristics such as a particle size and the like. In particular, in a case of the carbon black, the mechanical property may be deteriorated along with an increase in the particle size, and also deteriorated along with a reduction in an oil absorption number. Specifically, mechanical property of a molded article may be deteriorated due to characteristics of the specific coloring agent. Thus, according to the present exemplary embodiment, a type or characteristics of the pigment used for the coloring agent may be decided in order to minimize the deterioration of the mechanical property.

The pigment may be at least one compound selected from a group consisting of ZnS, carbon black, and lithopone. All of the compounds may have a surface hardness of about 5 or less. However, the carbon black is required to have a mean particle size of about 30 nm or less, and an oil absorption number of about 70 cc/100 g or more.

Also, a carbon black having an oil absorption number of about 70 cc/100 g to 150 cc/100 g may be used. The oil absorption number is a criterion of exhibiting a capacity for absorbing a liquid by the carbon black. When the oil absorption number of the carbon black is about 70 cc/100 g or less, the mechanical property of the article is deteriorated, and when the oil absorption number thereof is about 150 cc/100 g or more, moldability is deteriorated.

Also, the pigment having a mean particle size of about 20 nm or less may be used. The mechanical property of the article may be deteriorated along with an increase in the particle size.

When a ratio of the thermoplastic polymer resin within the long fiber-reinforced colored pellet is greater than about 90 wt. %, impact strength and winding property may be deteriorated, and when the ratio thereof is less than 10 wt. %, moldability may be deteriorated. Accordingly, the thermoplastic polymer resin may be about 10 to 90 wt. % based on the entire pellet.

Also, when the thermoplastic polymer resin has an MI of about 0.1 g/10 min or less at about 230° C. and under about 2.16 kg load, productivity may be reduced, or flow marks may occur on final productions. Also, when the thermoplastic polymer resin has an MI of about 80 g/10 min or more, desired mechanical properties may be difficult to obtain regarding impact resistance, tensile strength, impact strength, winding strength, and the like. Accordingly, the thermoplastic polymer resin may have an MI of about 0.1 to 80 g/10 min at about 230° C. and under about 2.16 kg load.

Also, the thermoplastic polymer resin includes at least one polymer resin selected from a group consisting of polypropylene, polyamide, polystyrene, styrene acrylonitrile (SAN), acrylonitrile-butadiene-styrene (ABS), polycarbonate (PC), polyurethane (PU), polyoxymethylene (POM), polyethylene terephthalate (PET), polytrimethylene terphthalate (PTT), poly butylene terephthalate (PBT), poly phenylene sulfide (PPS), poly phenylene ether (PPE), poly ether ether kentone (PEEK), liquid crystal polymer (LCP), polyarylate (PAR), poly methyl pentene (PMP), polysulfone (PSU), poly ether sulfone (PES), and polyimide (PI). Theses polymer resins may be used alone, or a combination thereof.

Of these thermoplastic polymer resins, the polyolefin-based polymer resin may be used alone or mixed with a rubber resin. The rubber resin is mixed with at least one copolymer selected from a group consisting of ethylene-α-olefin copolymer with three or more carbon atoms, and styrene-diene copolymer.

The ethylene-α-olefin copolymer may include α-olefin and ethylene with three or more carbon atoms, and the ethylene may be contained in about 10 to 90 wt. % in the ethylene-α-olefin copolymer, and more preferably, about 15 to 85 wt. %.

The ethylene-α-olefin copolymer includes at least one copolymer selected from a group consisting of ethylene-propylene copolymer, ethylene-butene-1 copolymer, and ethylene-octene copolymer.

An aromatic vinyl compound may be contained in about 10 to 50 wt. % in the styrene-diene copolymer. When an amount of the aromatic vinyl compound in the styrene-based copolymer rubber is about 10 wt. % or less, moldability may be deteriorated, and when the amount of the aromatic vinyl compound therein is about 50 wt. % or more, impact resistance at low temperature may be reduced. The styrene-diene copolymer rubber is a block copolymer including the aromatic vinyl compound such as styrene, vinyl toluene, methyl styrene, and a diene compound such as butadiene, isoprene, and the like, and a compound obtained by adding hydrogen to the styrene-diene copolymer may be used as the styrene-diene copolymer rubber.

As representative examples of the styrene-diene copolymer rubber, styrene-butylene-styrene block copolymer, styrene-ethylene-butylene-styrene block copolymer, stylene-isoprene-stylene block copolymer, and stylene-ethylene-propylene-stylene block copolymer may be given, and these copolymers may be used alone or in a combination thereof.

Also, the polyolefin-based polymer may be modified by unsaturated carboxylic acid and a derivative of unsaturated carboxylic acid. The polyolefin based-polymer is grafted in at least one polar group selected from a group consisting of unsaturated carboxylic acid, a derivative of unsaturated carboxylic acid, and an organosilane compound, and a degree of grafting is about 0.3 to 5 wt. %.

As the modified polyolefin-based polymer, modified polypropylene may be used. The modified polypropylene may be obtained by grafting, in polypropylene, a polar group such as unsaturated carboxylic acid, a derivative of unsaturated carboxylic acid, an organosilane compound, and the like. In this instance, when the degree of grafting is about 0.3 wt. % or less, bending property, strength, and adhesiveness with urethane foam may be deteriorated, and when the degree of grafting is about 5.0 wt. % or more, impact strength may be reduced. Accordingly, the degree of the grafting is about 0.3 to 5.0 wt. %, and preferably, about 0.5 to 5.0 wt. %.

As examples of the unsaturated carboxylic acid used upon the graft reaction, maleate, fumaric acid, acrylic acid, itaconic acid, and methacrylic acid may be given. Also, as examples of the derivative of unsaturated carboxylic acid used upon the graft reaction, anhydride such as maleate anhydride and itaconic anhydride, and ester such as maleate monoamide, acrylic acid amide, and methacrylic acid natrium, amide, metal salt, and the like may be given. As examples of the organosilane compound, amino silane, epoxy silane, vinyl silane, and methacryloxy silane may be given, and the present invention is not limited thereto. The modified polypropylene may be manufactured by grafting, in a polypropylene resin, any one selected from the above-mentioned polar groups, or any combination thereof.

When an amount of the modified polypropylene is about 1 wt. %, improvement in strength, bending property, and adhesiveness with urethane foam may be difficult to obtain, and when the amount of the modified polypropylene is about 10 wt. % or more, impact strength may be reduced. Accordingly, the modified polypropylene may be preferably contained in about 1 to 10 wt. % with respect to the entire long fiber-reinforced colored pellet.

The long fiber-reinforced colored pellet may be formed into a cylinder shape, oval shape, a Rugby ball shape, a flat cylinder shape, and the like, and a length of the long fiber-reinforced colored pellet is about 5 to 50 mm. The fiber reinforced material has a mean diameter of about 0.3 to 50 μm, is immersed in the pellet to be parallel to a lengthwise direction of the pellet, and has the same length as that of the pellet. The length of the fiber reinforced material within the long fiber-reinforced colored pellet is preferably about 5 to 50 mm. When the length of the fiber reinforced material is about 5 mm or less, transformation quantity may be increased, and strength of a weldline part may be reduced, and when the length of the fiber reinforced material is about 50 mm or more, injection from a hopper of a molding apparatus to a cylinder is impossible, thereby reducing moldability.

The fiber reinforced material is at least one fiber selected from a group consisting of glass fiber, carbon fiber, metal fiber, nylon fiber, PET fiber, PEEK fiber, LCP fiber, polyacrylonitrile (PAN) fiber, ultra-high molecular weight polyethylene (PE) fiber, aramid fiber, and natural fiber.

Also, in order to increase wettability for a polymer, the fiber reinforced material may use suitable surface treatment agents, for example, coupling agents such as silane, titanate, aluminum, chromium, zirconium, and borane, and may be subjected to an acid treatment. In a case of the glass fiber being mainly used, when y-aminopropyl trimethoxysilane such as silane based-coupling agents, an epoxy based-coupling agents such as y-glycidoxypropyltrimethoxysilane, and an vinyl silane-based coupling agents such as vinyl trichlorosilane may be used, the wettability for a polymer may be significantly improved.

When an amount of the fiber reinforced material within the entire long fiber-reinforced colored pellet is about 5 wt. % or less, the transformation quantity may increase, desired bending property may not be exhibited, and mechanical property-reinforced effects may be reduced. When the amount of the fiber reinforced material is about 85 wt. % or more, moldability may be deteriorated. Accordingly, the fiber reinforced material may be contained in about 5 to 85 wt. % within the long fiber-reinforced colored pellet, and preferably, about 15 to 45 wt. %.

Hereinafter, a pellet composition for a reinforced resin in which a colored pellet and a long fiber-reinforced pellet are mixed will be described in detail.

The pellet composition for the reinforced resin includes a colored pellet including about 50 to 90 wt. % of a first thermoplastic polymer resin, and about 10 to 50 wt. % of a pigment having a surface hardness of about 5 or less, and a long fiber reinforced pellet including about 10 to 90 wt. % of a second thermoplastic polymer resin, and about 10 to 90 wt. % of a fiber reinforced material having a length of about 5 to 50 mm. The first thermoplastic polymer resin and the second thermoplastic polymer resin may be the same, or different from each other.

Descriptions of the first and second thermoplastic polymer reins, the pigment, and the fiber reinforced material may be the same as in the above-mentioned long fiber-reinforced colored pellet, and the repeated descriptions will be omitted.

The colored pellet and the long fiber reinforced pellet are mixed in a weight ratio of about 0.02:99.98 to 50:50 in a dry mixing manner. A composition ratio of respective elements after mixing may be included in the composition ratio of the above-described long fiber-reinforced colored pellet. Specifically, an article manufactured by molding the pellet composition for the reinforced resin in which a) the colored pellet and b) the long fiber reinforced pellet are mixed may have the same composition ratio as in an article manufactured by molding the long fiber-reinforced color pellet. Also, c) a rein pellet including only a third thermoplastic polymer resin may be further added in the pellet composition for the reinforced resin, thereby controlling the entire composition ratio of the pellet composition for the reinforced resin.

Also, the pellet composition for the reinforced resin may further include a long fiber-reinforced colored pellet. Specifically, the pellet composition for the reinforced resin may include a) a long fiber-reinforced colored pellet including about 10 to 90 wt. % of a fourth thermoplastic polymer resin, about 5 to 85 wt. % of a fiber reinforced material having a length of about 5 to 50 mm, and about 0.01 to 5 wt. % of a pigment having a surface hardness of about 5 or less, b) a colored pellet including about 50 to 90 wt. % of a fifth thermoplastic polymer resin, and about 10 to 50 wt. % of a pigment having a surface hardness of about 5 or less, and c) a long fiber reinforced pellet including about 10 to 90 wt. % of a sixth thermoplastic polymer resin, and about 10 to 90 wt. % of a fiber reinforced material having a length of about 5 to 50 mm. Similarly, the pellet composition for the reinforced resin may further include d) a resin pellet including a seventh thermoplastic polymer resin. An article manufactured by molding the pellet composition for the reinforced resin including a), b), and c), or the pellet composition for the reinforced resin including a), b), c), and d) may have the same composition ratio as in an article manufactured by molding the long fiber-reinforced colored pellet.

Also, the pellet composition for the reinforced resin may include about 10 to 70 wt. % of a long fiber-reinforced colored pellet, about 5 to 80 wt. % of a colored pellet, and about 10 to 90 wt. % of a long fiber reinforced pellet. The pellet composition for the reinforced resin may be mixed with the long fiber-reinforced colored pellet, the colored pellet, and the long fiber reinforced pellet, so that the pellet composition may include about 10 to 90 wt. % of a thermoplastic polymer resin, about 5 to 85 wt. % of a fiber reinforced material having a length of about 5 to 50 mm, and about 0.01 to 5 wt. % of a pigment having a surface hardness of about 5 or less.

Also, The pellet composition for the reinforced resin may be mixed with the long fiber-reinforced colored pellet, the colored pellet, the long fiber reinforced pellet, and the resin pellet, so that the pellet composition may include about 10 to 90 wt. % of a thermoplastic polymer resin, about 5 to 85 wt. % of a fiber reinforced material having a length of about 5 to 50 mm, and about 0.01 to 5 wt. % of a pigment having a surface hardness of about 5 or less.

A composition ratio of an article manufactured in a combination of proper pellets selected from a group consisting of the long fiber-reinforced colored pellet, the colored pellet, the long fiber reinforced pellet, and the resin pellet may have a specific value.

The article may be a colored resin article including a fiber reinforced material. In this instance, a mean length of the fiber reinforced material is about 1 to 5 mm, and a surface hardness of the resin article is about 5 or less.

Hereinafter, the present invention will be described in detail by examples. It is to be understood, however, that these examples are for illustrative purpose only, and are not construed to limit the scope of the present invention.

### Examples 1 to 3 and Comparative Examples 1 to 3

A long fiber-reinforced colored pellet was manufactured using a modified polypropylene (mPP), in which a polypropylene resin (PP) having a Melt Index (MI) of about 12 g/10 min at a temperature of about 230° C. and under about 2.16 kg load, and maleic anhydride were grafted in polypropylene by about 1%, also using a glass fiber (LGF) having a diameter of about 17 μm and a pigment. As the pigment, ZnS (ZS), lithopone (LP), and a carbon black (CB 3) having a particle size of about 15 nm, and an oil absorption number of about 105 cc/100 g were respectively used in Examples 1, 2, and 3. Also, as the pigment, a titanium oxide (TiO₂, TO), another carbon black (CB 1) having a particle size of about 60 nm and an oil absorption number of about 90 cc/100 g, and another carbon black (CB 2) having a particle size of about 24 nm and an oil absorption number of about 55 cc/100 g were respectively used in Comparative Examples 1, 2, and 3. Here, elements and a weight ratio between the elements used in Examples 1 to 3, and Comparative Examples 1 to 3 are shown in Table 1 below.

TABLE 1

| | | | | | | | CB | CB | CB |
|---|---|---|---|---|---|---|---|---|---|
| | PP | mPP | LGF | TO | ZS | LP | 1 | 2 | 3 |
| Example 1 | 49.7 | 10 | 40 | | 0.3 | | | | |
| Example 2 | 49.7 | 10 | 40 | | | 0.3 | | | |
| Example 3 | 49.5 | 10 | 40 | | | | | | 0.5 |
| Comparative | 49.7 | 10 | 40 | 0.3 | | | | | |
| Example 1 | | | | | | | | | |
| Comparative | 49.5 | 10 | 40 | | | | 0.5 | | |
| Example 2 | | | | | | | | | |
| Comparative | 49.5 | 10 | 40 | | | | | 0.5 | |
| Example 3 | | | | | | | | | |

According to the composition in Table 1, a long fiber-reinforced colored pellet having a length of about 10 mm was manufactured so that a length of the glass fiber is the same as that of the pellet. In order to measure tensile strength, bending strength, and IZOD impact strength of the manufactured pellet using an injection machine having a clamping force of about 150 tons in accordance with American Society for Testing and Materials (ASTM) standards, samples were manufactured, and the physical property was measured based on ASTM standards. The tensile strength, the bending strength, and the IZOD impact strength were measured at room temperature (about 23° C.) using Notched samples based on ASTM D638, ASTM D790, and ASTM D256, respectively.

Ten samples were estimated to obtain mean values with respect to the respective physical properties, and the results are shown in Table 2 below.

TABLE 2

| | Tensile | Bending | IZOD impact |
|---|---|---|---|
| | strength | strength | strength |
| | (kgf/cm²) | (kgf/cm²) | (kgf cm/cm) |
| Example 1 | 1325 | 1852 | 20.8 |
| Example 2 | 1317 | 1828 | 21.1 |
| Example 3 | 1352 | 1872 | 20.7 |
| Comparative | 985 | 1226 | 9.3 |
| Example 1 | | | |
| Comparative | 1058 | 1732 | 11.1 |
| Example 2 | | | |
| Comparative | 1159 | 1788 | 14.5 |
| Example 3 | | | |

Each surface hardness of ZS and LP used in Examples 1 to 3 was about 3 to 4, a surface hardness of CB was about 1 to 2, and a surface hardness of TO used in Comparative Example 4 was about 7 to 8.

As can be seen in the results, in Comparative Example 1 using TO having a surface hardness of about 5 or more, all of the tensile strength, the bending strength, and the IZOD impact strength were significantly reduced in comparison with Examples 1 to 3 using the pigment having a surface hardness of about 5 or less. As compared between Example 3 and Comparative Examples 2 and 3, the tensile strength, the IZOD impact strength may be significantly reduced depending on a particle size of the pigment although the pigment provides a surface hardness of about 5 or less. Specifically, different physical properties were shown depending on the particle size and oil absorption number even when a carbon black having a surface hardness of about 5 or less was used as the pigment. Specifically, a carbon black having a mean particle size of about 30 nm or less and an oil absorption number of about 70 cc/100 g or more (Example 3) was superior in the tensile strength, the bending strength, and the IZOD impact strength. Also, in a case of a carbon black having a relatively large particle size of about 60 nm (Comparative Example 2), and in a case of another carbon black having a relatively small oil absorption number of about 55 cc/100 g (Comparative Example 3), the tensile strength and IZOD impact strength were reduced.

### Examples 4 to 6 and Comparative Examples 4 to 6

A long fiber-reinforced pellet having a length of about 10 mm was manufactured using a modified polypropylene (mPP), in which a polypropylene resin (PP) having a Melt Index (MI) of about 12 g/10 min at a temperature of about 230° C. and under about 2.16 kg load, and maleic anhydride were grafted in polypropylene by about 1%, also using a glass fiber (LGF) having a diameter of about 17 μm. In this instance, a length of the LGF immersed in the long fiber reinforced pellet was the same as that of the pellet.

Also, PP having an MI of about 12 g/10 min at about 230° C. and under about 2.16 kg load, a dispersing agent, and a pigment were configured in a composition ratio as shown in Table 3 below, and a colored pellet was manufactured using a twin screw extruder. As the pigment, ZS, LP, and CB 3 having a particle size of about 15 nm and an oil absorption number of about 105 cc/100 g were respectively used in Examples 4, 5, and 6. Also, as the pigment, TO, CB 1 having a particle size of about 60 nm and an oil absorption number of about 90 cc/100 g, and CB 2 having a particle size of about 24 nm and an oil absorption number of about 55 cc/100 g were respectively used in Comparative Examples 4, 5, and 6.

Here, elements and a weight ratio between the elements used in Examples 4 to 6, and Comparative Examples 4 to 6 were shown in Table 3 below.

TABLE 3

| | | | | Colored pellet | | | | | | | | |
|---|---|---|---|---|---|---|---|---|---|---|---|---|
| | Long fiber reinforced pellet | | | | Dispersing | | | | | | | Mixed |
| | PP | mPP | LGF | PP | agent | TO | ZS | LP | CB 1 | CB 2 | CB 3 | ratio |
| Example 4 | 50 | 10 | 40 | 65 | 5 | | 30 | | | | | 99:1 |
| Example 5 | 50 | 10 | 40 | 65 | 5 | | | 30 | | | | 99:1 |
| Example 6 | 50 | 10 | 40 | 65 | 5 | | | | | | 25 | 98:2 |
| Comparative | 50 | 10 | 40 | 65 | 5 | 30 | | | | | | 99:1 |
| Example 4 | | | | | | | | | | | | |
| Comparative | 50 | 10 | 40 | 65 | 5 | | | | 25 | | | 98:2 |
| Example 5 | | | | | | | | | | | | |
| Comparative | 50 | 10 | 40 | 65 | 5 | | | | | 25 | | 98:2 |
| Example 6 | | | | | | | | | | | | |

TABLE 4

| | Tensile | Bending | IZOD impact |
|---|---|---|---|
| | strength | strength | strength |
| | (kgf/cm²) | (kgf/cm²) | (kgf cm/cm) |
| Example 4 | 1307 | 1808 | 20.2 |
| Example 5 | 1321 | 1832 | 20.8 |
| Example 6 | 1332 | 1847 | 20.5 |
| Comparative | 992 | 1183 | 10.5 |
| Example 4 | | | |
| Comparative | 1012 | 1685 | 12.5 |
| Example 5 | | | |
| Comparative | 1188 | 1810 | 14.1 |
| Example 6 | | | |

In Examples 4 to 6 and Comparative Examples 4 to 6, the similar results as those in Examples 1 to 3 and Comparative Examples 1 to 3 were obtained. Mechanical property varied depending on the surface hardness and particle size of the pigment. Excellent productions without a great reduction in physical properties were manufactured even when the colored pellet containing a large amount of the coloring agent was used.

### INDUSTRIAL APPLICABILITY

As described above, according to the present invention, an article having excellent mechanical properties such as tensile strength, bending strength, and impact strength may be manufactured using the pellet composition for the reinforced resin in which the long fiber-reinforced colored pellet, the colored pellet, and the long fiber reinforced pellet are mixed. Also, an excellent article without a deterioration in physical properties may be manufactured even when using the colored pellet containing a large amount of the pigment.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A long fiber-reinforced colored pellet, comprising:
a thermoplastic polymer resin;
a fiber reinforced material having a length of about 5 to 50 mm; and
a pigment,
wherein the thermoplastic polymer resin has a melt index (MI) of about 0.1 to 80 g/10 min at about 230° C. and under about 2.16 kg load, and a surface hardness of the pigment is about 5 or less.

2. The long fiber-reinforced colored pellet of claim 1, comprising:
about 10 to 90 wt. % of the thermoplastic polymer resin;
about 5 to 85 wt. % of the fiber reinforced material; and
about 0.01 to 5 wt. % of the pigment.

3. The long fiber-reinforced colored pellet of claim 1, wherein the fiber reinforced material has a mean diameter of about 0.3 to 50 μM, and has the same length as that of the long fiber-reinforced colored pellet.

4. The long fiber-reinforced colored pellet of claim 1, wherein the pigment is at least one compound selected from a group consisting of ZnS, carbon black, and lithopone.

5. The long fiber-reinforced colored pellet of claim 4, wherein the pigment has a mean particle size of about 30 nm or less, and is carbon black having an oil absorption number of about 70 cc/100 g or more.

6. The long fiber-reinforced colored pellet of claim 5, wherein the pigment includes carbon black having an oil absorption number of about 70 to 150 cc/100 g.

7. The long fiber-reinforced colored pellet of claim 1, wherein the thermoplastic polymer resin includes at least one polymer resin selected from a group consisting of polypropylene, polyamide, polystyrene, styrene acrylonitrile (SAN), acrylonitrile-butadiene-styrene (ABS), polycarbonate (PC), polyurethane (PU), polyoxymethylene (POM), polyethylene terephthalate (PET), polytrimethylene terphthalate (M), poly butylene terephthalate (PBT), poly phenylene sulfide (PPS), poly phenylene ether (PPE), poly ether ether kentone (PEEK), liquid crystal polymer (LCP), polyarylate (PAR), poly methyl pentene (PMP), polysulfone (PSU), poly ether sulfone (PES), and polyimide (PI).

8. The long fiber-reinforced colored pellet of claim 1, wherein the thermoplastic polymer resin is polyolefin based-polymer, in which at least one copolymer is mixed, the at least one copolymer being selected from a group consisting of ethylene-α-olefin copolymer with three or more carbon atoms, and styrene-diene copolymer.

9. The long fiber-reinforced colored pellet of claim 8, wherein the ethylene-α-olefin copolymer includes at least one copolymer selected from a group consisting of ethylene-propylene copolymer, ethylene-butene-1 copolymer, and ethylene-octene copolymer.

10. The long fiber-reinforced colored pellet of claim 8, wherein the styrene-diene copolymer includes at least one copolymer selected from a group consisting of styrene-butylene-styrene block copolymer, styrene-ethylene-butylene-styrene block copolymer, stylene-isoprene-stylene block copolymer, and stylene-ethylene-propylene-stylene block copolymer.

11. The long fiber-reinforced colored pellet of claim 8, wherein the polyolefin based-polymer is grafted in at least one polar group selected from a group consisting of unsaturated carboxylic acid, a derivative of unsaturated carboxylic acid, and an organosilane compound, and a degree of grafting is about 0.3 to 5 wt. %.

12. The long fiber-reinforced colored pellet of claim 1, wherein the fiber reinforced material is at least one fiber selected from a group consisting of glass fiber, carbon fiber, metal fiber, nylon fiber, PET fiber, PEEK fiber, LCP fiber, polyacrylonitrile (PAN) fiber, ultra-high molecular weight polyethylene (PE) fiber, aramid fiber, and natural fiber.

13. The long fiber-reinforced colored pellet of claim 1, further comprising:
at least one additive selected from a group consisting of antioxidant, neutralizer, nucleant, anti-electrostatic agent, frame retardant, polish, ultraviolet stabilizer, slip agent, release agent, dispersing agent, and inorganic filter.

14. A pellet composition for a reinforced resin, comprising:
a colored pellet including about 50 to 90 wt. % of a first thermoplastic polymer resin, and about 10 to 50 wt. % of a pigment having a surface hardness of about 5 or less; and
a long fiber reinforced pellet including about 10 to 90 wt. % of a second thermoplastic polymer resin, and about 10 to 90 wt. % of a fiber reinforced material having a length of about 5 to 50 mm.

15. The pellet composition of claim 14, wherein the colored pellet and the long fiber reinforced pellet are mixed in a weight ratio of about 0.02:99.98 to 50:50.

16. The pellet composition of claim 14, further comprising:
a resin pellet including a third thermoplastic polymer resin.

17. The pellet composition of any one of claim 14 and claim 16, further comprising:
about 10 to 90 wt. % of a thermoplastic polymer resin;
about 5 to 85 wt. % of a fiber reinforced material having a length of about 5 to 50 mm; and
about 0.01 to 5 wt. % of a pigment having a surface hardness of about 5 or less.

18. The pellet composition of claim 14, wherein at least one thermoplastic polymer resin of the first and second thermoplastic polymer resins has an MI of about 0.1 to 80 g/10 min at about 230° C. and under about 2.16 kg load.

19. A pellet composition for a reinforced resin, comprising:
a) a long fiber-reinforced colored pellet including about 10 to 90 wt. % of a fourth thermoplastic polymer resin, about 5 to 85 wt. % of a fiber reinforced material having a length of about 5 to 50 mm, and about 0.01 to 5 wt. % of a pigment having a surface hardness of about 5 or less;
b) a colored pellet including about 50 to 90 wt. % of a fifth thermoplastic polymer resin, and about 10 to 50 wt. % of a pigment having a surface hardness of about 5 or less; and
c) a long fiber reinforced pellet including about 10 to 90 wt. % of a sixth thermoplastic polymer resin, and about 10 to 90 wt. % of a fiber reinforced material having a length of about 5 to 50 mm.

20. The pellet composition of claim 19, further comprising:
a resin pellet including a seventh thermoplastic polymer resin.

21. The pellet composition of claim 19, wherein the fourth thermoplastic polymer resin has an MI of about 0.1 to 80 g/10 min at about 230° C. and under about 2.16 kg load.

22. The pellet composition of claim 19, further comprising:
about 10 to 70 wt. % of the long fiber-reinforced colored pellet;
about 5 to 80 wt. % of the colored pellet; and
about 10 to 90 wt. % of the long fiber reinforced pellet.

23. The pellet composition of claim 19 or 20, further comprising:
about 10 to 90 wt. % of a thermoplastic polymer resin;
about 5 to 85 wt. % of a fiber reinforced material having a length of about 5 to 50 mm; and
about 0.01 to 5 wt. % of a pigment having a surface hardness of about 5 or less.

24. A colored resin article including a fiber reinforced material, wherein a mean length of the fiber reinforced material is about 1 to 5 mm, and a surface hardness of the resin article is about 5 or less.

25. The colored resin article of claim 24, wherein the colored resin article is formed using at least one of the long fiber-reinforced colored pellet of claim 1, the reinforced resin pellet composition of claim 14, and the reinforced resin pellet composition of claim 19.

26. The colored resin article of claim 24, wherein the resin article includes a resin having an MI of about 0.1 to 80 g/10 min at about 230° C. and under about 2.16 kg load.
